(19) United States
(12) Patent Application Publication
(10) Pub. No.: US 2012/0325983 A1
(43) Pub. Date: Dec. 27, 2012

(54) TEMPLATE ASSEMBLY FOR CONDUIT INSTALLATION

(76) Inventor: Peter A. Vrame, Barrington Hills, IL (US)

(21) Appl. No.: 13/165,296

(22) Filed: Jun. 21, 2011

(51) Int. Cl. F16L 3/223; B23P 11/00; F16L 3/22

(52) U.S. Cl. 248/68.1; 29/428

(57) ABSTRACT

A template assembly is configured to facilitate efficient installation of a plurality of conduits in generally parallel relationship with each other. The assembly includes at least one template member having a generally planar configuration, with a plurality of conduit-receiving openings defined therein. A template support can be provided which is configured to receive the template member in a generally vertical orientation. It is contemplated that a plurality of the template assemblies, including a plurality of the template members and template supports, are arranged and spaced apart relationship along a plurality of generally parallel conduits, so that that conduits, and template assemblies can be positioned, as an integrated unit, thus facilitating efficient installation and positioning of the conduits. Another aspect of the present invention contemplates that at least one stabilizing element is inserted through one or more of the template members, and into the surrounding region. Floating of the assembly during pouring of associated concrete is desirably abated, as the concrete covers and stabilizes the template supports.

### TECHNICAL FIELD

The present invention relates generally to arrangements for mounting plurality of conduits or ducts, and more particularly to template assembly for simultaneously positioning of plurality of generally parallel conduits or ducts, with the assembly including a template member through which the conduits extend, and one or more associated stabilizing elements, and an associated template support, which receives the template member and which provides a base upon which the template member and conduits can be positioned. The arrangement desirably abates “floating” of the conduits and templates during introduction of stabilizing material such as concrete.

### BACKGROUND ART

There are many instances during road maintenance, building construction, sewer construction and like construction projects wherein it is necessary to position and install a plurality of generally parallel conduits or ducts. While it is known to use various spacers and the like which are positionable between adjacent ones of the conduits, any technique by which installation is facilitated desirably reduces installation costs.

The present invention contemplates a template assembly for use in conduit installation, which greatly facilitates such installation by permitting a plurality of conduits to be handled as an assembly, and positioned as desired, such as in an associated trench or the like. Notably, the provision of a lower support component desirably abates “floating”, or the tendency of the conduits to rise, during pouring of concrete or the like.

### SUMMARY OF THE INVENTION

A template assembly embodying the principle of the present invention facilitates installation of a plurality of generally parallel conduits or ducts. The assembly comprises at least one, and preferably a plurality of template members each having a generally planar configuration. Each template member defines a plurality of conduit-receiving openings, sized for receiving the associate conduits.

The present template assembly can further include a template support configured to receive the template member in a generally vertical orientation thereof. By this arrangement, the plurality of conduits can be positioned to extend through a plurality of spaced apart ones of the template members. The template members, in turn, are each positioned in a generally vertical orientation within a respective one of the template supports. The template members and template supports are preferably secured to each other, so that the conduits, template members, and template supports can all be handled, as an integrated unit or an assembly, for positioning in the desired location, such as a trench. Efficient installation of the conduits is thus greatly facilitated. Notably, the tendency of the conduits to “float” or rise such as during the pouring of concrete is desirably abated, as the concrete covers and stabilizes the template support

In accordance with the illustrated embodiment, the template member has a generally planar configuration, and defines a plurality of conduit-receiving openings therein. The template support of the assembly is configured to receive the template member in a generally vertical orientation thereof. The template support can be provided in any of a variety of configurations, and includes a lower base portion, and a pair of generally upstanding support portions positionable on respective opposite sides of the template member when the template member is received in the template support.

The template member and template support are configured to cooperate with a plurality of associated, generally elongated conduits by disposition of the conduits through the template member. By this arrangement, the template member and template support can be assembled with the conduits to permit simultaneous handling and positioning of the conduits, with the conduits positioned in the template member, and the template member conduits supported by the template support while the template support is positioned on its base portion.

In one illustrated embodiment, the base portion of the template support is generally planar, and the support portions of the template support extend upwardly from the base portion in generally parallel relationship to define a channel there between for receiving the conduit template member. In an alternative embodiment, the template support is generally tubular, and includes a lower portion which provides the base portion thereof, and an upper portion which provides the pair of outstanding support portions positionable on respective opposite sides of the conduit template. It is within the purview of the present invention that such a tubular template support can be provided with a variety of cross-sectional configurations, including a generally circular cross-section, or a generally polygonal cross-section.

If desired, the template support can be configured to have a generally telescopic configuration whereby the length of the template support can be selectively varied.

In the preferred form, each of the conduit template and template support defines at least one securement opening through which an associated securement member, such as a zip tie, can extend for securing the conduit template and the support to each other.

In accordance with the present invention, a method of positioning a plurality of conduits comprises the steps of providing a plurality of the generally planar conduit templates, each having a plurality of openings through which the plurality of conduits respectively extend. The present method further contemplates providing a plurality of the conduit supports, each having a base portion, and a pair of upstanding support portions.

The conduit templates are positioned in a generally vertical orientation within respective ones of the template supports, and the conduit templates secured to the respective conduit supports. Thereafter, the conduits, conduit template and template supports can be positioned as an integrated assembly, such as in an associated trench or the like, thus greatly facilitating efficient installation of the conduits in a generally parallel orientation. Suitable fill or the like can thereafter be supplied, depending upon the specific configuration.

In another aspect of the present invention, the template members can optionally be provided with one or more openings through which one or more stabilizing elements, such as steel rods, can be inserted. Thus, at least one stabilizing element can be inserted through the template member and into the region adjacent the integrated assembly, such as into the wall of the associated trench.

Other features and advantages of the present invention will become readily apparent from the following detailed description, the accompanying drawings, and the appended claims.

### BRIEF DESCRIPTION OF THE DRAWINGS

FIG. 1 is a perspective, diagrammatic view of a template assembly for conduit installation embodying the principles of the present invention;

FIG. 2 is a diagrammatic, perspective view illustrating positioning of a plurality of conduits, with a plurality of template assemblies, in accordance with the present invention;

FIG. 3 is a diagrammatic view illustrating a template support of the present invention, having a telescopic configuration;

FIGS. 4-15 are diagrammatic, cross-section illustrations of the template support of the present template assembly; and

FIG. 16 is a diagrammatic view, similar to FIG. 2, illustrating use of a stabilizing element in accordance with the present invention.

### DETAILED DESCRIPTION OF THE PREFERRED EMBODIMENT

While the present invention is susceptible of embodiment in various forms, there is shown in the drawings, and will hereinafter be described, presently preferred embodiments, with the understanding that the present disclosure is to be considered as an exemplification of the invention, and is not intended to limit the invention to the specific embodiment illustrated.

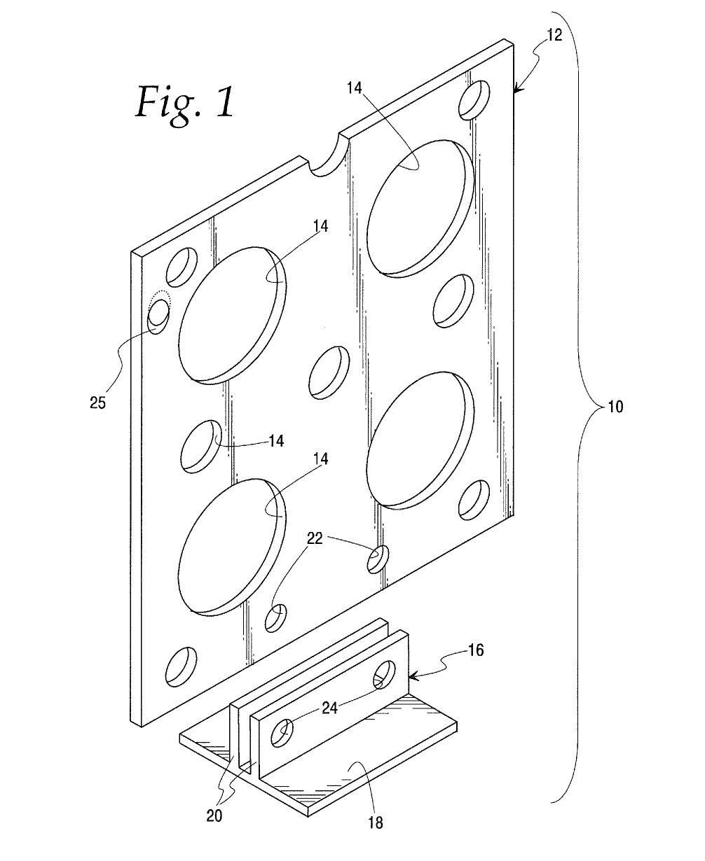

With reference first to FIG. 1, therein is illustrated a template assembly 10 embodying the principals of the present invention. In accordance with the present invention, it is contemplated that a plurality of the template assemblies 10 be provided in association with a plurality of generally parallel conduits, to facilitate installation of the conduits, together with the plurality of template assemblies, as an integrated assembly or unit. Stable, accurate, and efficient installation of the conduits is thus facilitated, while avoiding “floating” of the conduits such as during their immersion in concrete or the like.

As illustrated in FIG. 1, the conduit assembly 10 includes a conduit template 12 having a generally planar configuration. The template member 12 has a plurality of conduit-receiving openings 14 defined therein, which can be variously sized for receiving differently-sized conduits there through. Openings in the template member can also be provided for receiving reinforcing steel bar, or like structural components, to facilitate integration and installation of a plurality of generally parallel conduits. The template member may be efficiently formed from suitable polymeric material, such as high density polyethylene. The thickness of the template member can be varied, depending upon application, and may be sized from a thickness on the order of ⅜ inch up to 2 inches.

The template assembly 10 further includes a template support 16 which is configured to receive the template member 12 in a generally vertical orientation thereof. The specific configuration of the template support can be varied in accordance with the principles disclosed herein, but the template support essentially includes a lower base portion, and a pair of generally upstanding support portions positionable on respective opposite sides of the template member 12 when the template member 12 is received in the template support. In this illustrated embodiment, the template support 12 includes a base portion 18 having a generally planar configuration, and a pair of upstanding support portions 20 which extend upwardly from the base portion and generally parallel, spaced apart relationship to define a channel there between for receiving the conduit template member 12. The template supports may be provided in suitable pre-cut lengths, or can be provided in the form of an elongated member, such as 5-10 feet in length, with individual ones of the supports cut to length.

In the preferred embodiment, each of the template member 12 and template support 16 define at least one, and preferably a plurality, of securement openings through which one or more associated securement members, such as zip ties, can extend for securing the template member and template support to each other. In this illustrated embodiment, the template member includes a pair of securement openings 22, while the support portions 20 of the template support 16 define securement openings 24 positionable in alignment with the securement openings defined by the template member. By way of example, ¼ inch pilot holes can be provided at 6-inch spacing.

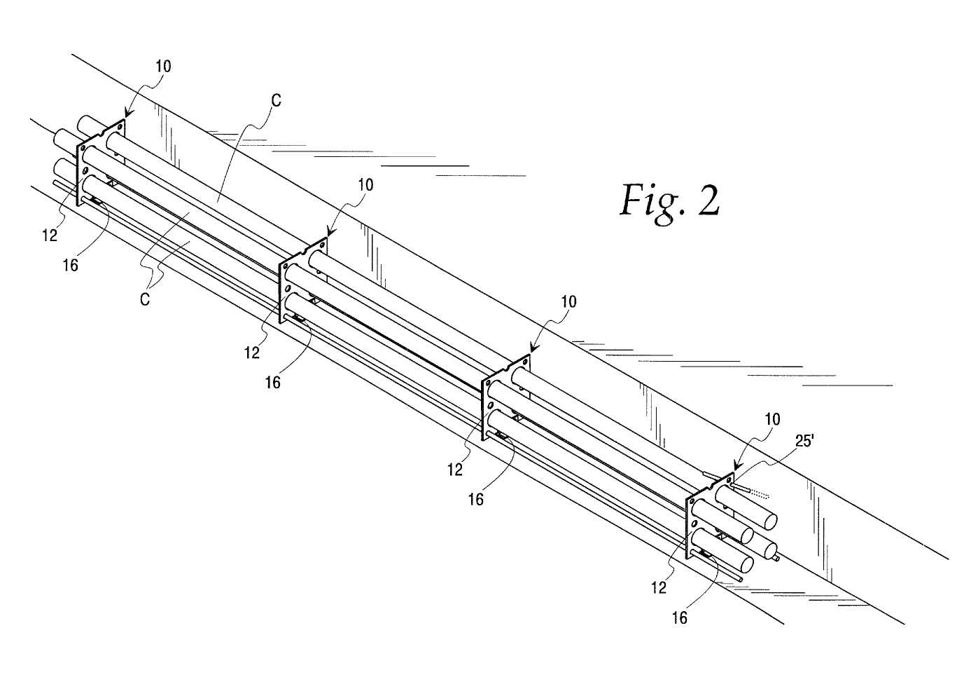

FIG. 2 illustrates the method of employing a plurality of template assemblies of the present invention for positioning a plurality of generally parallel conduits C. As will be observed, a plurality of the generally planar conduit templates have been provided, with each having a plurality of openings through which the plurality of conduits C respectively extend, in generally parallel relationship with each other. A plurality of the template supports 16 are provided, with the template members 12 respectively positioned, in a generally vertical orientation, within the template supports 16. Preferably, each conduit template is secured to a respective one of the template supports, such as by the provision of suitable zip ties or like securement elements extending through the aligned ones of the securement openings 22 and 24.

By this arrangement of the template assemblies with the conduits, the conduit template member, and the template supports can be positioned as an integrated assembly, such as in an associated trench or the like. Suitable back fill or other material can thereafter be positioned around the conduits, with the base portion of each template support 16 providing secure and stable mounting of the integrated assembly.

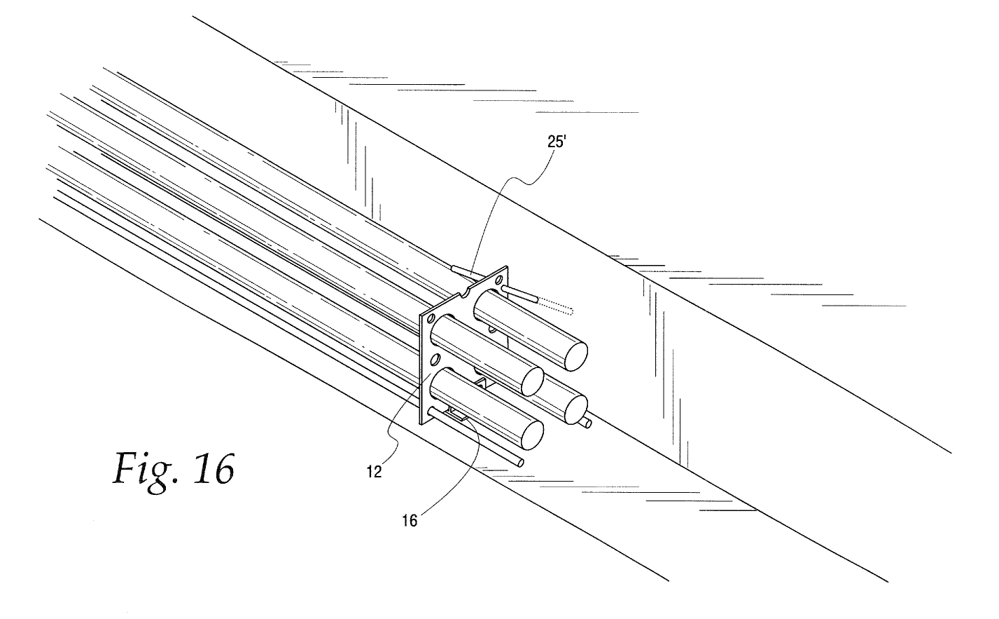

Stable and secure positioning of the conduit/template assembly can be enchanced by inserting at least one stabilizing element, such as a steel rod or bar, angularly through one or more of the templates and into the surrounding region, such as the wall of the trench. One or more openings 25 can be provided in each template member for this purpose, with such a stabilizing element 25′ shown in FIGS. 2 and 16.

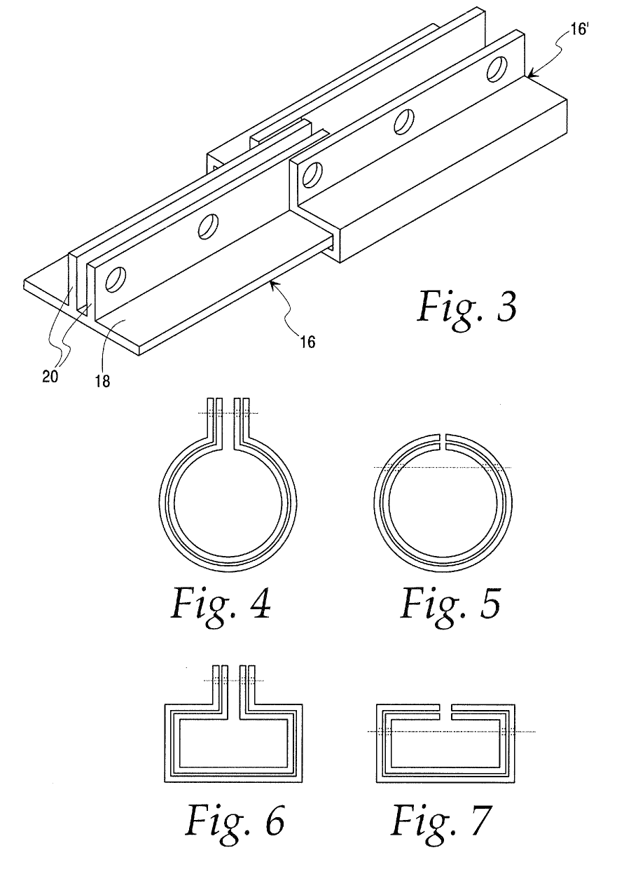

FIG. 3 illustrates an embodiment of the template support 16, wherein the template support is provided with a telescopic configuration. Thus, the template support 16 includes an outer portion 16 prime which can be telescopically positioned with respect to the template support 16, for selectively varying the length of the template support.

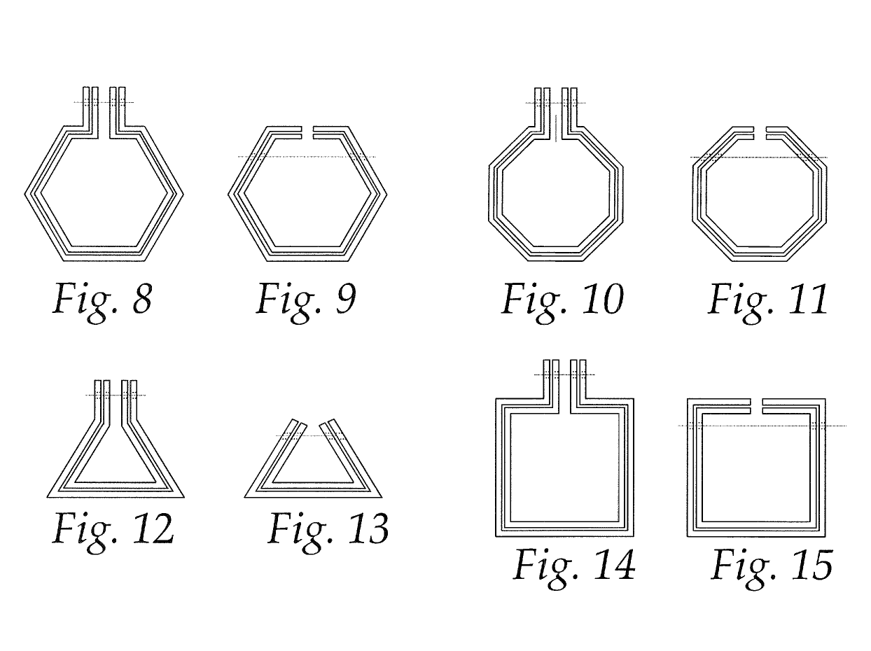

FIGS. 4-15 illustrate embodiments of the template support of the present invention each of which is generally tubular in configuration. In each of these embodiments, a lower portion of the template support provides the base portion thereof, while an upper portion provides the pair of upstanding support portions positionable on respective opposite sides of the associated template. In each of these embodiments, as illustrated, the template support can be provided with a telescopic configuration, by including complimentary, inner and outer portions to the template support member. Suitable securement openings can be provided, as shown, for cooperation with securement openings on the associated template member, such as for receiving securement elements in the form of zip ties or the like.

In the embodiments of FIGS. 4 and 5, the generally tubular template supports illustrated therein are provided with a generally circular cross-section.

In the embodiments of FIGS. 6 and 7, the tubular template supports are provided with a generally polygonal cross-section, in this case, a generally rectangular cross-section.

In the embodiments of FIGS. 8 and 9, the tubular support members are provided with a generally polygonal cross-section, in these embodiments hexagonal cross-section.

In the embodiments of FIGS. 10 and 11, the tubular support members are provided with a generally polygonal cross-section, which is generally octogonal in these embodiments.

In the embodiments of FIGS. 12 and 13, the generally tubular support members are provided with a generally polygonal cross-section, which is generally triangular in these embodiments.

In the embodiments of FIGS. 14 and 15, the tubular template supports are provided with a generally polygonal cross-section, which is generally square in these embodiments.

FIG. 16 illustrates use of stabilizing element 25′, which can be inserted through one of the openings 25 provide in one or more of the template members 12, and into the region surrounding the assembly of conduits and template members, such as the surrounding trench. Each template member 12 can be provided with one or more of the openings 25, so that one or more of the stabilizing elements 25′ can be respectively positioned to extend through the template member and into the surrounding trench. “Floating” and like displacement of the conduits, attendant to introduction of concrete or a like filling/anchoring material into the trench, is thus desirably abated. Fabrication of the stabilizing elements from suitable material such as steel reinforcing bars (“rebar”) is contemplated.

From the foregoing, it will be observed that numerous modifications and variations can be effected without departing from the true spirit and scope of the novel concept of the present invention. It is to be understood that no limitation with respect to the specific embodiments illustrated herein is intended or should be inferred. Disclosure is intended to cover, by the appended claims, all such modifications as fall within the scope of the claims.

What is claimed is:

1. A template assembly for conduit installation, comprising:
at least one template member having a generally planar configuration, said template
member having a plurality of conduit-receiving openings defined therein; and
a template support configured to receive said template member in a generally vertical orientation thereof, said template support including a lower base portion, and a pair of generally upstanding support portions positionable on respective opposite sides of said template member when said template member is received in said template support,
said template member and said template support being configured to cooperate with a plurality of associated, generally elongated conduits by disposition of said conduits through said template member, whereby said template member and said template support can be assembled with said conduits to permit simultaneous handling and positioning of said conduits with said conduits positioned in said template member, and said template member and said conduits supported by said template support while the template support is positioned on its base portion.

2. A template assembly in accordance with claim 1, wherein
said base portion of said template support is generally planar, and said support portions of said template support extend upwardly from said base portion in generally parallel relationship to define a channel therebetween for receiving said conduit template member.

3. A template assembly in accordance with claim 1, wherein
said template support member comprises a telescopic assembly for selectively adjusting the length of said template support member.

4. A template assembly in accordance with claim 1, wherein
said template support is generally tubular, including a lower portion which provides said base portion thereof, and a upper portion which provides said pair of upstanding support portions positionable on respective opposite sides of said template member.

5. A template assembly in accordance with claim 4, wherein
said template support has a generally circular cross-section.

6. A template assembly in accordance with claim 4, wherein
said template support has a generally polygonal cross-section.

7. A template assembly in accordance with claim 1, wherein
each of said conduit template and said template support defines at least one securement opening through which an associated securement member extends for securing said conduit template and said template support to each other.

8. A template assembly in accordance with claim 1, wherein
said template member defining at least one opening to permit insertion of a stabilizing element there through and into the surrounding region.

9. A method of positioning a plurality of conduits, comprising the steps of:
providing a plurality of generally planar template members each having a plurality of openings through which said plurality of conduits respectively extend;
providing a plurality of template supports each having a base portion and a pair of upstanding support portions;
positioning each of said templates members in a generally vertical orientation within are respective one of said template supports, and securing each template member to the respective one of said template supports; and
positioning said conduits, said template members and said template supports as an integrated assembly.

10. A method of positioning a plurality of conduits in accordance with claim 9, wherein
at least some of said template supports have a telescopic configuration.

11. A method of positioning a plurality of conduits in accordance with claim 9, wherein
at least some of said template supports have a generally tubular configuration.

12. A method of positioning a plurality of conduits in accordance with claim 9, including
inserting at least one stabilizing element through one or more of said template members and into the region adjacent said integrated assembly.

13. A method of positioning a plurality of conduits, comprising the steps of:
providing a plurality of generally planar template members each having a plurality of openings through which said plurality of conduits respectively extend;
providing a plurality of stabilizing elements;
positioned each of said templates members in a generally vertical orientation;
position said conduits and said template members as an integrated assembly; and
inserting at least one of said stabilizing elements through a respective one of said template members and into the region adjacent said integrated assembly.

14. A method of position a plurality of conduits in accordance with claim 13, including
providing a plurality of template support each having a pair of upstanding support portions, and positioning at least some of same conduits into respective ones of said template support prior to positioning of said conduit and template members as an integrated assembly.
